(19) United States
(12) Patent Application Publication
(10) Pub. No.: US 2011/0304953 A1
(43) Pub. Date: Dec. 15, 2011

(54) Nanostructured thin-film electrochemical capacitors

(75) Inventors: Chongwu Zhou, Arcadia, CA (US); Po-Chiang Chen, Hillsboro, OR (US); Jing Xu, Los Angeles, CA (US); Haitian Chen, Los Angeles, CA (US)

(73) Assignee: UNIVERSITY OF SOUTHERN CALIFORNIA, Los Angeles, CA (US)

(21) Appl. No.: 13/099,234

(22) Filed: May 2, 2011

Related U.S. Application Data
(60) Provisional application No. 61/330,181, filed on Apr. 30, 2010.

(51) Int. Cl. H01G 9/145; H01G 9/00; H01G 9/04; B82Y 99/00

(52) U.S. Cl. 361/508; 29/25.03; 977/762; 977/788; 977/948

(57) ABSTRACT

An asymmetric electrochemical capacitor including an anode, a cathode, and an electrolyte between the anode and the cathode. The anode includes manganese dioxide (MnO₂) nanowires and single-walled carbon nanotubes. The cathode includes indium oxide (In₂O₃) nanowires and single-walled carbon nanotubes. The asymmetrical electrochemical capacitor can be fabricated by forming a first film including manganese dioxide nanowires and single-walled carbon nanotubes, forming a second film including indium oxide nanowires and single-walled carbon nanotubes, and providing an electrolyte between the first film and the second film such that the electrolyte is in contact with the first film and the second film.

### CROSS-REFERENCE TO RELATED APPLICATION

This application claims priority to U.S. Application Ser. No. 61/330,181, filed on Apr. 30, 2010, which is incorporated by reference herein.

### FEDERALLY SPONSORED RESEARCH OR DEVELOPMENT

The invention was made with government support under Computing and Communication Foundations Grant Nos. CCF 0726815 and CCF 0702204 awarded by the National Science Foundation. The government has certain rights in the invention.

### TECHNICAL FIELD

This invention relates to nanostructured thin-film electrochemical capacitors and devices including nanostructured thin-film electrochemical capacitors.

### BACKGROUND

Electrochemical capacitors, or supercapacitors, have been fabricated with high-surface-area carbonaceous materials. Hybrid electrochemical capacitors, or asymmetric supercapacitors (ASCs), in which the electrodes have different active material, have also been fabricated.

### SUMMARY

Supercapacitors are formed from flexible, mesoporous, and uniform hybrid nanostructured thin film electrodes. These hybrid nanostructured asymmetric supercapacitors exhibit improved operation voltage, specific capacitance, energy density, and power density over single-walled carbon nanotube (SWNT) symmetric supercapacitors. This improved performance may be attributed at least in part to enhanced charge storage (e.g., from electrical double-layer capacitance of SWNT films) and pseudocapacitance (e.g., from transition-metal-oxide nanowires), good conductivity of SWNTs, and the adjusted mass balance, facilitating operation of the devices in a 2 V potential window with stable electrochemical behavior. In addition, the total weight of the supercapacitors can be further reduced because binders and metal current collecting electrodes are not needed for operation. The asymmetric supercapacitors have demonstrated specific capacitance over 180 F/g, power density over 50 kW/kg, and energy density over 25 Wh/kg, and are suitable for use in conformal electronics, portable electronics, and electrical vehicles.

In a first aspect, an asymmetric electrochemical capacitor includes an anode, a cathode, and an electrolyte between the anode and the cathode. The anode includes manganese dioxide (MnO₂) nanowires and single-walled carbon nanotubes. The cathode includes indium oxide (In₂O₃) nanowires and single-walled carbon nanotubes.

In another aspect according to the first aspect, the anode includes a manganese dioxide nanowire/single-walled carbon nanotube hybrid film.

In another aspect according to the first aspect, the anode is free of added binder materials.

In another aspect according to the first aspect, the anode does not include a metal layer.

In another aspect according to the first aspect, the cathode includes an indium oxide nanowire/single-walled carbon nanotube hybrid film.

In another aspect according to the first aspect, the cathode is free of added binder materials.

In another aspect according to the first aspect, the cathode does not include a metal layer.

In another aspect according to the first aspect, a separator is sandwiched between the anode and the cathode. In some implementations, the separator includes nitrocellulose or a transition metal oxide.

In another aspect according to the first aspect, the electrolyte is an aqueous electrolyte. In some implementations, the electrolyte includes sodium sulfate (Na₂SO₄).

In another aspect according to the first aspect, specific capacitance of the asymmetric electrochemical capacitor is greater than 180 F/g.

In another aspect according to the first aspect, power density of the asymmetric electrochemical capacitor is greater than 50 kW/kg.

In another aspect according to the first aspect, the energy density of the asymmetric supercapacitor is greater than 25 Wh/kg.

In another aspect according to the first aspect, a device includes the asymmetric electrochemical capacitor.

In a second aspect, fabricating an asymmetric electrochemical capacitor includes forming a first film comprising manganese dioxide nanowires and single-walled carbon nanotubes, forming a second film comprising indium oxide nanowires and single-walled carbon nanotubes, and providing an electrolyte between the first film and the second film such that the electrolyte is in contact with the first film and the second film.

In another aspect according to the second aspect, the first film includes manganese dioxide nanowire/single-walled carbon nanotube hybrid film.

In another aspect according to the second aspect, forming the first film includes forming a layer of manganese dioxide nanowires over a layer of single-walled carbon nanotubes.

In another aspect according to the second aspect, the second film includes an indium oxide nanowire/single-walled carbon nanotube hybrid film.

In another aspect according to the second aspect, forming the second film includes forming a layer of indium oxide nanowires over a layer of single-walled carbon nanotubes.

In another aspect according to the second aspect, a separator is arranged between the first film and the second film, and the electrolyte is in contact with the separator.

In another aspect according to the second aspect, an electrochemical capacitor is fabricated by a process including forming a first film including manganese dioxide nanowires and single-walled carbon nanotubes, forming a second film including indium oxide nanowires and single-walled carbon nanotubes, and providing an electrolyte between the first film and the second film such that the electrolyte is in contact with the first film and the second film.

These general and specific aspects may be implemented using a device, system or method, or any combination of devices, systems, or methods. The details of one or more embodiments are set forth in the accompanying drawings and the description below. Other features, objects, and advantages will be apparent from the description and drawings, and from the claims.

### BRIEF DESCRIPTION OF THE DRAWINGS

FIG. 1 depicts a hybrid nanostructured asymmetric supercapacitor (ASC).

FIGS. 2A-2C show scanning electron microscope (SEM) images of a scratched MnO₂ nanowire/single-walled carbon nanotube (SWNT) hybrid film.

FIGS. 3A-3B show SEM images of an In₂O₃ nanowire/SWNT hybrid film.

FIG. 4A shows a SEM image of β-MnO₂ nanowires. FIGS. 4B and 4C show transmission electron microscope (TEM) images of β-MnO₂ nanowires.

FIG. 5 shows an X-ray diffraction (XRD) spectrum of β-MnO₂ nanowires.

FIG. 6A shows a SEM image of In₂O₃ nanowires. FIGS. 6B and 6C show TEM images of In₂O₃ nanowires.

FIG. 7 shows an XRD spectrum of In₂O₃ nanowires.

FIGS. 8A-8C show cyclic voltammograms from a three-electrode configuration with different nanostructured thin film electrodes of a bare SWNT thin film electrode, a MnO₂ nanowire/SWNT hybrid film electrode, and an In₂O₃ nanowire/SWNT hybrid film electrode, respectively. FIG. 8D shows a comparative cyclic voltammogram using MnO₂ nanowire/SWNT hybrid film and In₂O₃ nanowire/SWNT hybrid film as active electrodes.

FIGS. 9A and 9B show cyclic voltammograms of an optimized hybrid nanostructured asymmetric supercapacitor in 1M Na₂SO₄ electrolyte with different scan rates.

FIG. 10 shows galvanostatic charging/discharging curves for a hybrid nanostructured asymmetric supercapacitor.

FIG. 11 shows a comparison of specific capacitance of a hybrid nanostructured asymmetric supercapacitor and a SWNT symmetric supercapacitor with different discharging currents.

FIG. 12 shows galvanostatic charging/discharging curves of an optimized asymmetric nanostructured supercapacitor.

FIG. 13 shows Coulombic efficiency and specific capacitance of a hybrid nanostructured asymmetric supercapacitor.

FIGS. 14A and 14B show photographs of an LED connected with a hybrid nanostructured asymmetric supercapacitor before and after discharging.

FIG. 15 is a Ragone plot showing performance of hybrid nanostructured asymmetric supercapacitors and SWNT symmetric supercapacitors.

### DETAILED DESCRIPTION

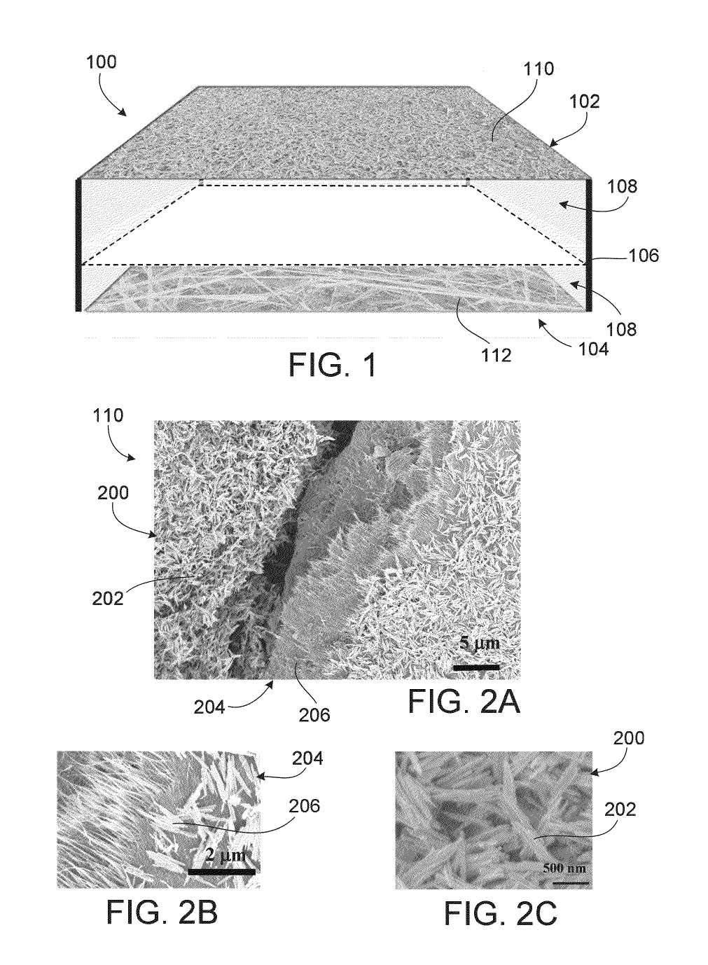

Referring to FIG. 1, asymmetric supercapacitor (ASC) 100 includes anode 102, cathode 104, and separator 106. Electrolyte 108 is present between anode 102 and cathode 104. Anode 102 includes a manganese dioxide (MnO₂) nanowire/single-walled carbon nanotube (SWNT) hybrid film 110. Cathode 104 includes an indium oxide (In₂O₃) nanowire/SWNT hybrid film 112. Separator 106 provides electrical insulation between electrodes 102 and 104 while allowing ions to move from one electrode to the other. In an example, nitrocellulose can be used as separator 106. Separator 106 can also include transition metal oxides, such as ruthenium oxide, tin oxide, magnetite, titanium oxide, and vanadium oxide. Suitable electrolytes include, for example, sodium sulfate, sulfuric acid, potassium hydroxide, potassium iodine, lithium salts such as LiClO₄ and LiPF₆, and ionic liquids.

The transition metal oxide/SWNT hybrid films 110 and 112 of electrodes 102 and 104, respectively, function as current collecting electrodes. As such, ASC 100 can operate in the absence of metal current collecting electrodes. Hybrid nanostructured films 110 and 112 provide mechanical flexibility, uniform layered structures, and mesoporous surface morphology. The SWNTs in the transition metal oxide/SWNT hybrid films contribute to electrical double-layer capacitance, and the transition metal oxide nanowires contribute to the high energy density and high power density of ASC 100. Thus, charge can be stored via electrochemical double-layer capacitance as well as through reversible Faradaic processes. As described herein, ASC 100 can be stably operated up to 2 V with specific capacitance over 180 F/g, power density over 50 kW/kg, and energy density over 25 Wh/kg.

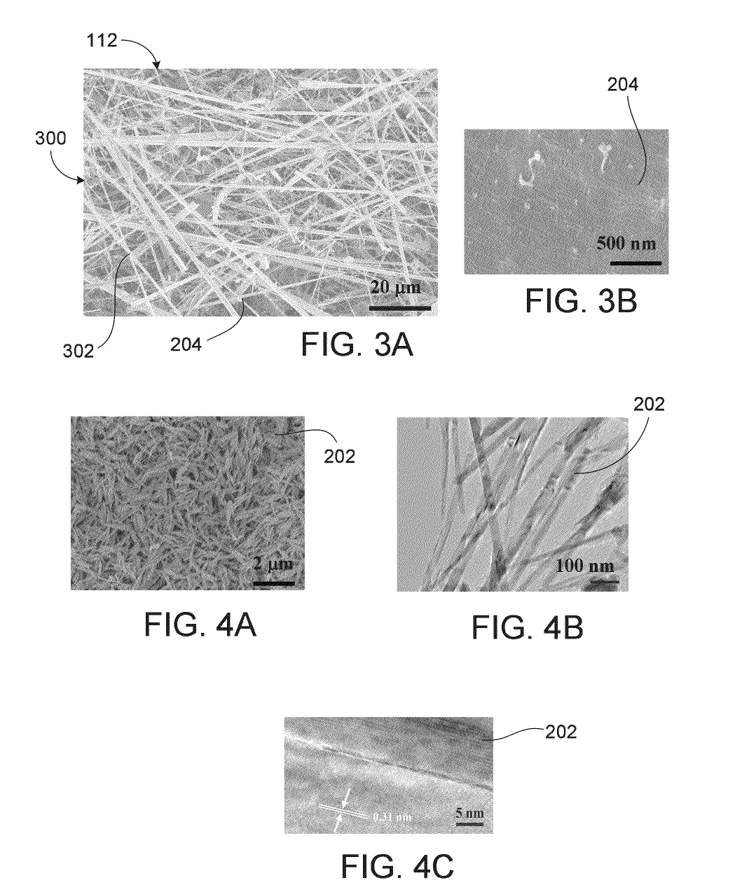

FIG. 2A shows a scanning electron microscope (SEM) image of MnO₂ nanowire/SWNT hybrid film 110 in which MnO₂ nanowire film 200 (including MnO₂ nanowires 202) is coated on SWNT film 204 (including SWNTs 206). The MnO₂ layer appears to be uniform. To observe the interface between the SWNT network and the MnO₂ nanowire mesh, the surface of a MnO₂ nanowire/SWNT hybrid film 110 was scratched. FIG. 2B shows a uniform network of SWNTs 206 in SWNT film 204 underneath MnO₂ nanowire film 200. FIG. 2C shows film 200 formed from MnO₂ nanowires 202. Film 200 appears to be a uniform, homogeneous layer over SWNT film 204. FIG. 3A shows SEM image of In₂O₃ nanowire/SWNT hybrid film 112 in which In₂O₃ nanowire film 300 (including In₂O₃ nanowires 302) is coated on SWNT film 204. FIG. 3B shows SWNT film 204 underneath In₂O₃ nanowire film 300.

MnO₂ nanowire/SWNT hybrid film 110 and In₂O₃ nanowire/SWNT hybrid film 112, formed with nanostructured materials, are flexible, conformal, and binder-free. The nanowire/SWNT films have tunable surfaces and are easily wet by aqueous electrolytes. As used herein, a “tunable surface” generally refers to a surface the properties of which can be altered to be hydrophobic or hydrophilic by surface functionalization or the formation of hybrid nanostructures. The apparent uniformity of the dispersed transition-metal-oxide nanowire and SWNT films in the layered structure of the electrode promote uniform charge distribution on each electrode, allowing the cell voltage to be split substantially equally on the electrodes.

To fabricate ASC 100, MnO₂ nanowire/SWNT hybrid film 110 and In₂O₃ nanowire/SWNT hybrid film 112 are formed separately, then assembled with separator 106 and electrolyte 108 to yield the ASC. The MnO₂ nanowire/SWNT hybrid film 110 and In₂O₃ nanowire/SWNT hybrid film 112 are fabricated in a process including forming a SWNT layer on a substrate and forming a metal oxide nanowire layer on the SWNT layer to form a metal oxide nanowire/SWNT hybrid film, then removing the metal oxide nanowire/SWNT hybrid film from the substrate. The metal oxide nanowire/SWNT hybrid films are then assembled with separator 106 and electrolyte 108 to form ASC 100.

In an example, electrodes 102 and 104 were fabricated in a layered approach. First, SWNT film 204 was fabricated by mixing arc-discharge carbon nanotubes (P3 nanotubes from Carbon Solutions Inc.) with 1 wt % aqueous sodium dodecyl sulfate (SDS) in distilled water to form a dense SWNT suspension with a concentration of about 0.1 mg/mL. Sodium dodecyl sulfate (SDS), a surfactant, was added to enhance the solubility of SWNTs (e.g., by sidewall functionalization). The SWNT solution was then ultrasonically agitated (e.g., using a probe sonicator for about 20 minutes), followed by centrifugation to separate out undissolved SWNT bundles and impurities. The SWNT suspension was filtered through a porous alumina filtration membrane (Anodisc, pore size: 200 nm, Whatman Ltd.) to form a uniform SWNT thin film electrode. As the solvent went through the membrane, SWNTs were trapped on the membrane surface and formed a homogenous entangled network. After the filtration, the SWNT network was washed with distilled water to remove SDS. After drying, the flexible SWNT Buckypaper was peeled off the filtration membrane. The mass of SWNT Buckypaper (and hybrid nanostructured films) was determined by a micro-balance after filtration. Typical mass loading of a 2-inch-diameter SWNT Buckypaper was about 8 mg, with a film thickness of 2.2 μm and sheet resistance of 13-16 Ω/□. The electrode size was about 0.5 cm².

To form MnO₂ nanowires, Mn(CH₃COO)₂.4H₂O and Na₂S₂O₈ (99.999%, Sigma Aldrich) were dissolved in 100 mL distilled water with a molar ratio of 1:1 at room temperature, and stirred by a magnetic stirrer to form a clear and homogeneous solution. The mixed solution was then transferred to a 130 mL Teflon-lined stainless steel autoclave and heated at 120° C. for 12 hours in an electrical oven. After hydrothermal reaction, the products were washed with deionized water and ethanol to remove the sulfate ions and other unwanted components by filtration. The products were then dried in a vacuum oven at 100° C. for 12 hours.

In₂O₃ nanowires were synthesized using a thermal chemical vapor deposition (CVD) method. A 5 nm gold film was deposited on Si/SiO₂ substrates as a catalyst using an e-beam evaporator, followed by annealing at 700° C. for 30 minutes. The substrates were then placed into a quartz tube at the downstream position of a furnace, while stoichiometric In₂O₃ powder (99.99%, Alfa-Aesar) mixed with graphite powder, utilized as a precursor, was placed at the center of the furnace. During the growth, the quartz tube was maintained at a pressure of 1 atm and a temperature of 900° C., with a constant flow of 120 standard cubic centimeters (sccm) for about 50 minutes. The as-grown nanowires were characterized by using field-emission scanning electron microscope (FESEM, Philips S-2000), high resolution transmission electron microscope (HR-TEM, JEOL 100-CX), and x-ray diffractometry (XRD).

FIG. 4A shows a SEM image of as-grown β-phase MnO₂ (β-MnO₂) nanowires 202 with an average length between about 2 μm and about 3 μm and an average diameter between about 10 nm and about about 30 nm. FIGS. 4B and 4C show transmission electron microscope (TEM) images of β-MnO₂ nanowires 202. Nanowires 202 appear to have a smooth surface without an amorphous coating and are substantially uniform in diameter. There is no noticeable dislocation or defect in the MnO₂ nanowires, and the corresponding HR-TEM image, shown in the inset, exhibits a single crystalline structure with a well-defined lattice fringe, corresponding to the d-spacing of 0.31 nm of β-MnO₂ crystal structure.

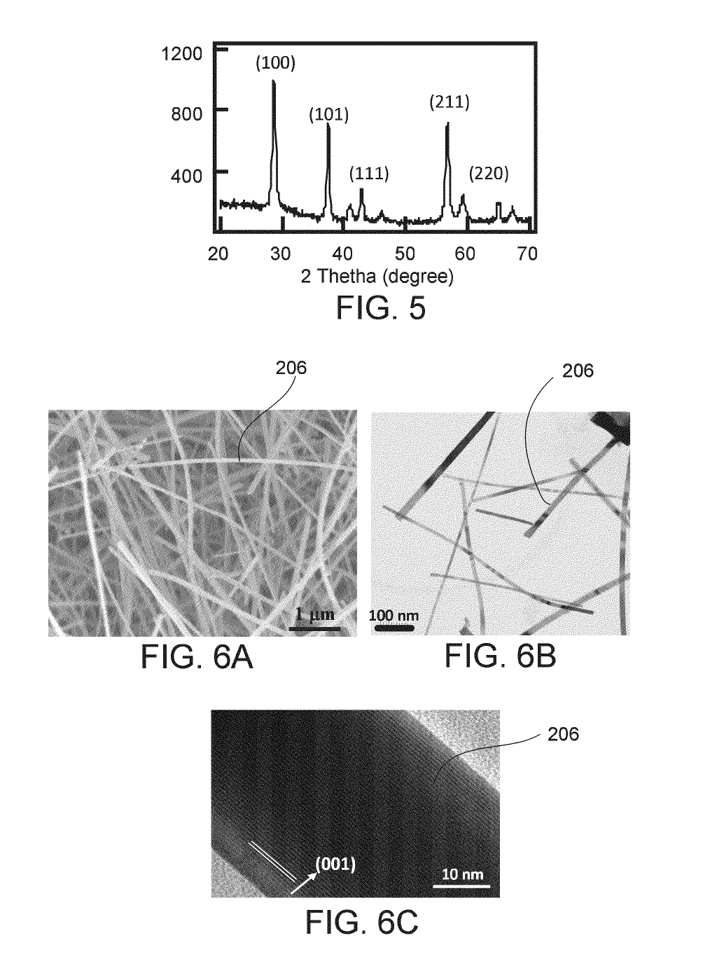

FIG. 5 shows an XRD pattern of β-MnO₂, which also confirmed the crystalline structure of the β-MnO₂ nanowires, having tetragonal symmetry with P42/mnm space group and lattice constants of a=4.388 nm and c=2.865 nm (JCPDS data (PDF-01-072-1984)). No extra peak was observed in the XRD spectrum, indicating, in agreement with the HR-TEM observations, the crystalline nature of the MnO₂ nanowires.

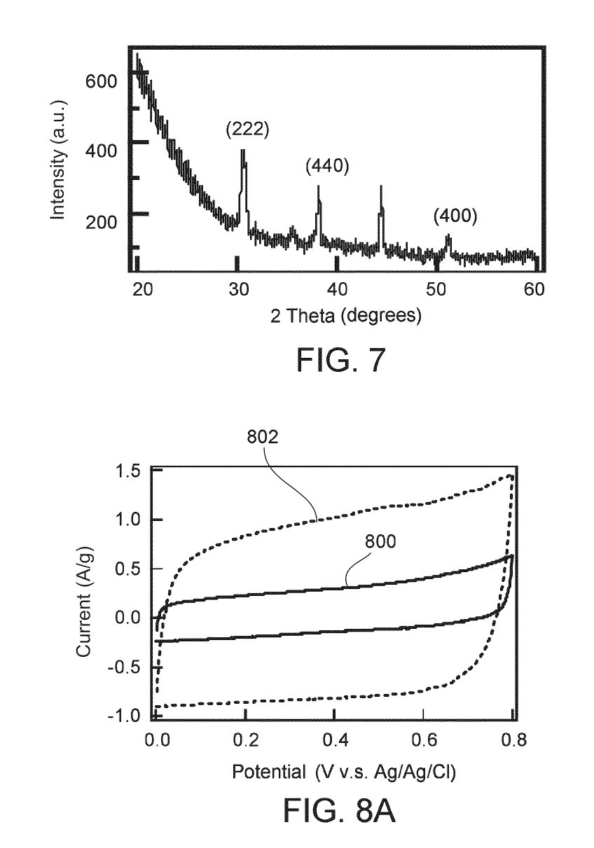

FIG. 6A shows a SEM image of CVD synthesized In₂O₃ nanowires 206, with an average length between about 10 μm and about 100 μm long and an average diameter of about 50 nm to about 100 nm. FIG. 6B shows a TEM image of In₂O₃ nanowires 206, and FIG. 6C shows a HR-TEM image of In₂O₃ nanowires 206. In₂O₃ nanowires 206 appear to have a single crystalline structure without noticeable dislocations or defects. The interspacing between each plane is 0.505 nm, corresponding to the <200> plane in the body-centered cubic (bcc) In₂O₃ nanowire crystal structure, with a lattice constant of a=1.01 nm. The XRD pattern shown in FIG. 7 exhibits two extra peaks believed to be due to the existence of gold catalysts. The XRD diffraction patterns also indicate that the In₂O₃ nanowires exhibit high crystalline quality.

To produce hybrid nanostructured films 110 and 112, the as-grown transition-metal-oxide nanowires were sonicated in isopropyl alcohol (IPA) and then dispersed on a SWNT film/anodic aluminum oxide (AAO) membrane to form transition-metal-oxide nanowire/SWNT hybrid films by a filtration method. As the suspension went through the SWNT film/filtration membrane, the nanowires were trapped on the SWNT film and formed an intertwined mesh. The “hybrid nanostructured thin films” were peeled off the filtration membrane and dried.

Electrochemical measurements were carried out with a potentiostat/galvanostat (263, Princeton Applied Research) in 1 M Na₂SO₄ electrolyte. Galvanostatic (GV) charging/discharging measurements were used to determine the specific capacitance (Cₛₚ), power density, and internal resistance (IR) of the devices in a two-electrode configuration. Cyclic Voltammetery (CV) measurements were performed to evaluate the stability and electrochemical behavior of the hybrid nanostructured films under different potentials from −0.6 V to 0.8 V in a three-electrode configuration. A hybrid nanostructured film, an Ag/AgCl (saturated NaCl) assembly, and a platinum wire were used as the working electrode, the reference electrode, and the counter electrode, respectively. The potential range of MnO₂ and In₂O₃ hybrid nanostructured films extends from 0.0 V to 0.8 V and −0.6 V to 2 V vs. Ag/AgCl, respectively. The In₂O₃ nanowires are more stable at more negative potentials.

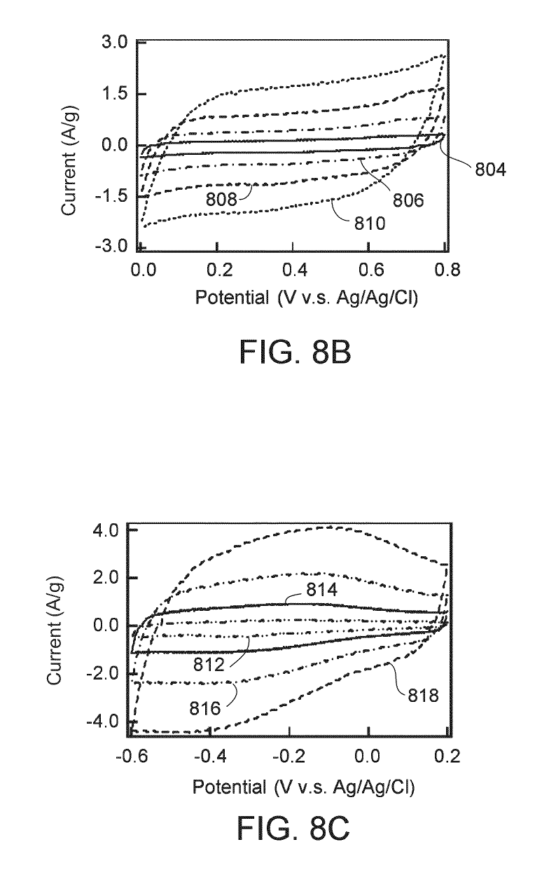

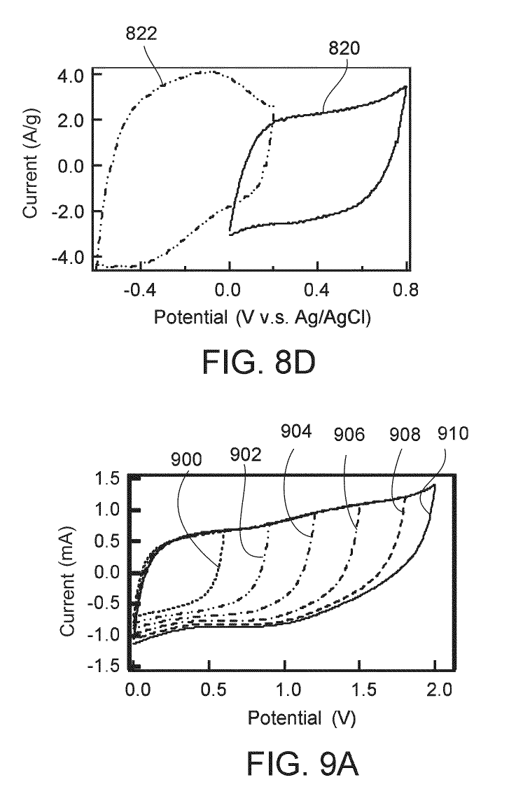

The CV results of SWNT Buckypaper, MnO₂ nanowire/SWNT hybrid films, and In₂O₃ nanowire/SWNT hybrid films in aqueous electrolyte are shown in FIGS. 8A-8C. FIG. 8A shows the results of CV measurements of SWNT Buckypaper with scan rates of 5 mV/sec (plot 800) and 20 mV/sec (plot 802) in the potential range of 0.0V and 0.8V. The rectangular shape of these curves reveals good electrical double-layer capacitance behavior of the SWNT Buckypaper. FIG. 8B shows cyclic voltammograms of MnO₂ nanowire/SWNT hybrid films with scan rates of 5 mV/sec (plot 804), 20 mV/sec (plot 806), 50 mV/sec (plot 808), and 100 mV/sec (plot 810). These curves have a quasi-rectangular shape.

The redox transition of MnO₂ is based on the injection and ejection of cations and electrons, in which cations (Na⁺) intercalate into a MnO₂ lattice and correspondingly Mn(IV) becomes Mn(III) to balance the charges. The reaction can be expressed as:

MnOₐ(OH)_{b}+nH⁺+ne⁻ [symbol] MnOₐ₋ₙ(OH)_{b+n}, (1)
in which MnOₐ(OH)_{b} and MnOₐ₋ₙ(OH)_{b+n} represent interfacial MnO₂.H₂O in higher and lower oxidation states, respectively. The quasi-rectangular shapes are close to the behavior of electric double-layer capacitors (EDLCs), even though Faradaic processes are thought to influence the electrochemical behavior of MnO₂ nanowire networks in an aqueous electrolyte. In addition, the SWNT films underneath MnO₂ nanowire networks also contributed to electrical double-layer capacitance, influencing the CV shapes of MnO₂ nanowire/SWNT hybrid films.

FIG. 8C shows the cyclic voltammograms of In₂O₃ nanowire/SWNT hybrid films with scan rates of 5 mV/sec (plot 812), 20 mV/sec (plot 814), 50 mV/sec (plot 816), and 100 mV/sec (plot 818). Similar to the MnO₂ nanowire/SWNT hybrid films, the In₂O₃ nanowire/SWNT films exhibit a quasi-rectangular shape. The cyclic voltammograms of FIGS. 8B and 8C have a different appearance than the cyclic voltammograms of FIG. 8A. This difference may be due at least in part to the Faradaic process contributed by the transition-metal-oxide nanowires.

The specific capacitance of the transition-metal-oxide nanowires can be obtained via the following equation:

$$C ( F / g ) = \frac{i}{v} ( \frac{1}{m} ) , \qquad ( 2 )$$

in which v is the scan rate, i is the corresponding current of the applied voltage, and m is the weight of the active materials. With this equation, the specific capacitance of SWNT Buckypaper is calculated to be about 80 F/g, the specific capacitance of MnO₂ nanowire/SWNT hybrid film is calculated to be 253 F/g, and the specific capacitance of In₂O₃ nanowire/SWNT hybrid film is calculated to be 201 F/g. By expressing the total cell voltage as the sum of the potential range of MnO₂ nanowire/SWNT hybrid film and In₂O₃ nanowire/SWNT hybrid film, it is estimated that the hybrid nanostructured asymmetric supercapacitors can be operated up to 1.4 V.

FIG. 8D shows the cyclic voltammograms obtained in a three-electrode cell from MnO₂ nanowire/SWNT hybrid film electrode (plot 820) and In₂O₃ nanowire/SWNT hybrid film electrode (plot 822) in 1 M Na₂SO₄ electrolyte. The MnO₂ nanowire/SWNT hybrid film has a stable electrochemical behavior in positive polarization, and the In₂O₃ nanowire/SWNT hybrid film has a stable electrochemical behavior in negative polarization. Hence, to obtain a capacitor operating in a 1.4 V voltage window, experimental conditions can be controlled (or “optimized”) for the MnO₂ nanowire/SWNT hybrid film to work in the potential window range from 0.2 V to 0.8V and for the In₂O₃ nanowire/SWNT hybrid film work in the potential window range from −0.6 V to 0.2 V to promote safe performance of both electrodes during long cycling. In this way, decomposition of the aqueous electrolyte at 1 V in a symmetric cell system may be reduced or avoided. In addition, more negative potential (for reduction) and positive potential (for oxidation) may be achieved, since both the hydrogen and oxygen evolution reactions are presumably kinetically limited on these transition-metal-oxide nanowires and SWNTs. As a result, the operation window of MnO₂ nanowires may extend from −0.1 V to 1.2 V vs. Ag/AgCl in 1M Na₂SO₄, and the operation window of In₂O₃ nanowires may extend from −1.0 V to 0.2 V vs. Ag/AgCl in 1M Na₂SO₄ electrolyte.

Moreover, unlike a symmetric supercapacitor, in which the applied voltage can split equally between the two electrodes due to use of the same material and having the same mass in each electrode, in asymmetric supercapacitors, the voltage-split depends on the capacitance of the active materials in each electrode. The capacitance is related to the mass and the specific capacitance of the active material. Thus, to split voltage equally, the mass balance between the two electrodes in the cell system can be adjusted (or “optimized”) following the relationship of q₊=q₋, in which q₊ refers to the charges stored at the positive electrode and q₋ refers to the charges stored at the negative electrode. The stored charge can be expressed as:

q=C_{SP}*m*ΔE (3)

In which ΔE is the potential range of charging/discharging process, and m is the mass of each electrode. Since the mass loading of SWNTs in each electrode is the same, the optimal mass ratio between the electrodes may be expressed as m_{MnO2}/m_{In2O3}=0.74 in the hybrid nanostructured asymmetric cell system.

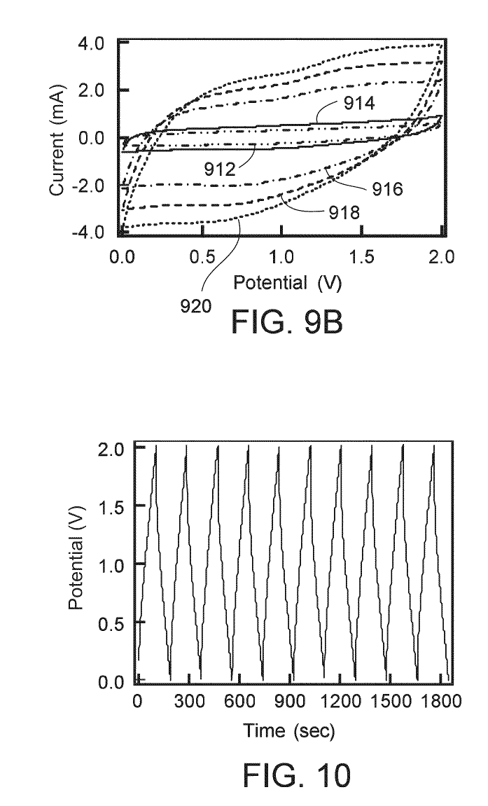

FIG. 9A shows cyclic voltammograms at 5 mV/sec (plot 900), 10 mV/sec (plot 902), 20 mV/sec (plot 904), 50 mV/sec (plot 906), 75 mV/sec (plot 908), and 100 mV/sec (plot 910) for a hybrid nanostructured asymmetric supercapacitor with optimal mass ratio between two electrodes. With a scan rate of 20 mV/sec (plot 904), the hybrid nanostructured supercapacitor shows quasi-rectangular CV curves even at a potential window up to 2.0 V in 1M Na₂SO₄ electrolyte. FIG. 9B shows current vs. potential of the asymmetric supercapacitor for scan rates of 5 mV/sec (plot 912), 10 mV/sec (plot 914), 20 mV/sec (plot 916), 50 mV/sec (plot 918), and 100 mV/sec (plot 920). Capacitive behavior even at the high scan rate of 100 mV/sec.

FIG. 10 shows 10 cycles of galvanostatic charging-discharging curves of an asymmetric supercapacitor with a constant current of 2 mA/cm² in the potential range between 0.01 V and 2.01 V. The symmetry of the charging and discharging characteristics shows good capacitive behavior. The specific capacitance has been evaluated from the charging-discharging curves, according to the following equation:

$${C}_{sp} = ( \frac{I}{- d V / d t} ) ( \frac{1}{{m}_{+}} + \frac{1}{{m}_{-}} ) \qquad ( 4 )$$

in which I is the applied discharging current, m₊ and m₋ are the mass of the positive and negative electrode, respectively, and dV/dt is the slope of the of discharge curve after IR drop. The power density and the energy density can be calculated using the following equations:

$$\begin{matrix}P = \frac{{V}^{2}}{4 RM} & ( 5 ) \\ E = \frac{1}{2} {CV}^{2} = \frac{1}{8} {MC}_{sp} {V}^{2} , & ( 6 )\end{matrix}$$

in which V is the applied voltage, R is the equivalent series resistance (ESR), M is the total mass of the hybrid nanostructured film electrodes, and C is the total capacitance of the hybrid nanostructured asymmetric supercapacitor

$$( {C}_{SP} = \frac{4 C}{M} ) .$$

The calculated specific capacitance of the hybrid nanostructured asymmetric supercapacitor is about 184 F/g, while the power density and energy density were 50.3 kW/kg and 25.5 Wh/kg, respectively.

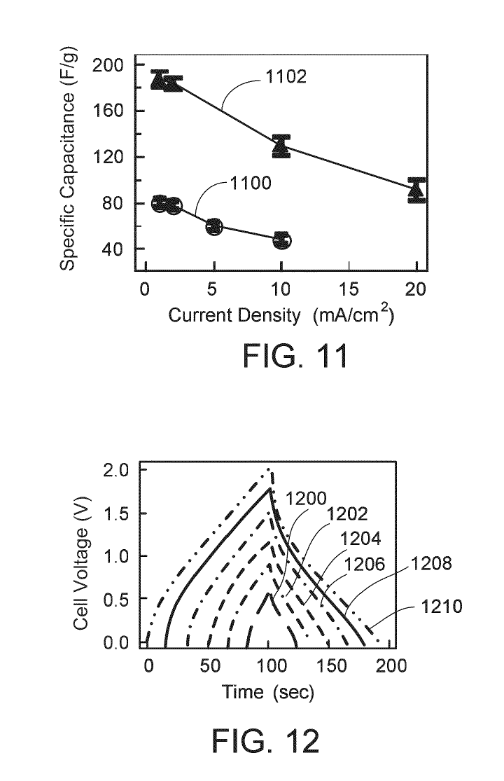

GV measurements were also made on SWNT symmetric supercapacitors. The specific capacitance was 80 F/g, with a power density of 11.4 kW/kg and an energy density of 4 Wh/kg. The device performance of hybrid nanostructured asymmetric supercapacitors and SWNT symmetric supercapacitors was further investigated by using different charging/discharging currents. FIG. 11 shows the specific capacitance of a SWNT symmetric supercapacitor (plot 1100) and a hybrid nanostructured asymmetric supercapacitor (plot 1102) as a function of discharging current density. The decrease of specific capacitance of both supercapacitors may be attributed to the decrease of the utilization efficiency of active materials with increasing discharging current. The hybrid nanostructured asymmetric supercapacitors showed a specific capacitance of 90 F/g even at a discharging current of 20 mA/cm².

FIG. 12 shows galvanostatic charging/discharging curves of a hybrid nanostructured asymmetric supercapacitor with different maximum cell voltage from 0.6 V (plot 1200), 0.8 V (plot 1202), 1.0 V (plot 1204), 1.4 V (plot 1206), 1.8 V (plot 1208), and 2.0 V (plot 1210). The specific discharge capacitance was improved with increasing cell voltage, and the charging/discharging behavior was capacitive with symmetric charge-discharge curves up to 1.5 V. However, with increasing cell voltage, non-capacitive behavior with non-symmetric charge-discharge curve was found. Therefore, to determine the most appropriate or optimal cell voltage, the Coulombic efficiency was evaluated according to the following equation:

$$η = \frac{{q}_{d}}{{q}_{c}} \times 100 \% \qquad ( 7 )$$

In which q_{d} and q_{c} are the total amount of discharge and charge of the capacitor obtained from the galvanostatic data shown in FIG. 12.

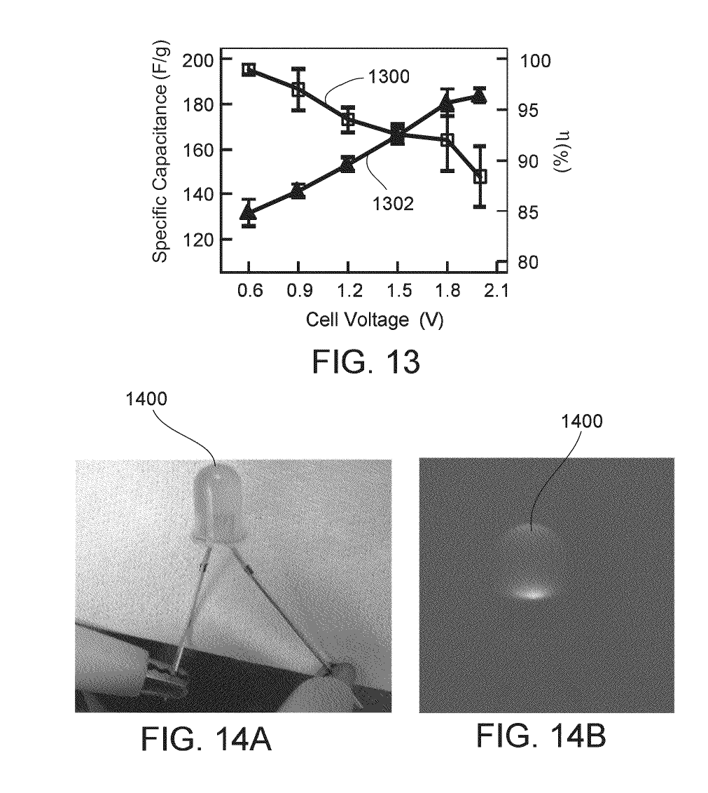

FIG. 13 shows the Coulombic efficiency (plot 1300) and the average specific discharge capacitance (plot 1302) of both electrodes as a function of the cell voltage in five hybrid nanostructured asymmetric supercapacitors. The capacitance increases with the cell voltage; the Coulombic efficiency decreases with voltage.

To show a practical application of hybrid nanostructured asymmetric supercapacitors, a hybrid nanostructured asymmetric supercapacitor was connected to green light-emitting diode (LED) 1400, as shown in FIG. 14A. LED 1400 was successfully lit, as shown in FIG. 14B.

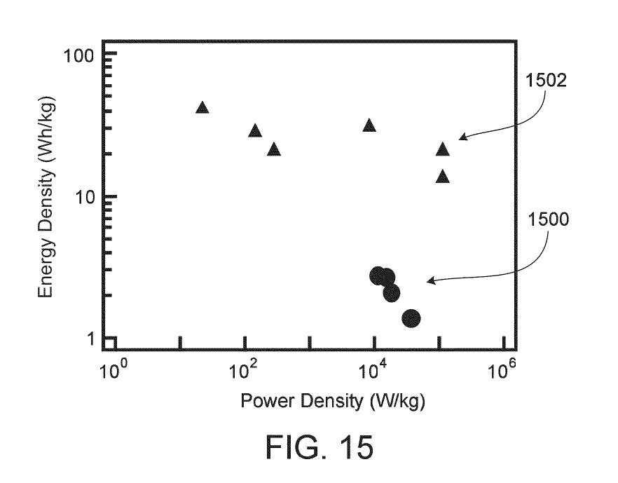

FIG. 15 shows Ragone plots of SWNT symmetric supercapacitors (1500) and hybrid nanostructured asymmetric supercapacitors (1502). All the data were calculated based on the total mass of active materials of the two electrodes. It can be seen that the hybrid nanostructured asymmetric supercapacitors exhibit higher energy density and power density than the SWNT symmetric supercapacitors.

Further modifications and alternative embodiments of various aspects will be apparent to those skilled in the art in view of this description. Accordingly, this description is to be construed as illustrative only. It is to be understood that the forms shown and described herein are to be taken as examples of embodiments. Elements and materials may be substituted for those illustrated and described herein, parts and processes may be reversed, and certain features may be utilized independently, all as would be apparent to one skilled in the art after having the benefit of this description. Changes may be made in the elements described herein without departing from the spirit and scope as described in the following claims.

What is claimed is:

1. An asymmetric electrochemical capacitor comprising:
an anode comprising manganese dioxide (MnO₂) nanowires and single-walled carbon nanotubes;
a cathode comprising indium oxide (In₂O₃) nanowires and single-walled carbon nanotubes; and
an electrolyte between the anode and the cathode.

2. The asymmetric electrochemical capacitor of claim 1, wherein the anode comprises a manganese dioxide nanowire/single-walled carbon nanotube hybrid film.

3. The asymmetric electrochemical capacitor of claim 1, wherein the anode is free of added binder materials.

4. The asymmetric electrochemical capacitor of claim 1, wherein the anode does not include a metal layer.

5. The asymmetric electrochemical capacitor of claim 1, wherein the cathode comprises an indium oxide nanowire/single-walled carbon nanotube hybrid film.

6. The asymmetric electrochemical capacitor of claim 1, wherein the cathode is free of added binder materials.

7. The asymmetric electrochemical capacitor of claim 1, wherein the cathode does not include a metal layer.

8. The asymmetric electrochemical capacitor of claim 1, further comprising a separator sandwiched between the anode and the cathode.

9. The asymmetric electrochemical capacitor of claim 8, wherein the separator comprises nitrocellulose.

10. The asymmetric electrochemical capacitor of claim 1, wherein the electrolyte is an aqueous electrolyte.

11. The asymmetric electrochemical capacitor of claim 10, wherein the electrolyte comprises sodium sulfate (Na₂SO₄).

12. The asymmetric electrochemical capacitor of claim 1, wherein specific capacitance of the asymmetric electrochemical capacitor is greater than 180 F/g.

13. The asymmetric electrochemical capacitor of claim 1, wherein power density of the asymmetric electrochemical capacitor is greater than 50 kW/kg.

14. The asymmetric electrochemical capacitor of claim 1, wherein the energy density of the asymmetric supercapacitor is greater than 25 Wh/kg.

15. A device comprising the asymmetric electrochemical capacitor of claim 1.

16. A method of fabricating an asymmetric electrochemical capacitor, the method comprising:
forming a first film comprising manganese dioxide nanowires and single-walled carbon nanotubes;
forming a second film comprising indium oxide nanowires and single-walled carbon nanotubes;
providing an electrolyte between the first film and the second film such that the electrolyte is in contact with the first film and the second film.

17. The method of claim 16, wherein the first film comprises manganese dioxide nanowire/single-walled carbon nanotube hybrid film.

18. The method of claim 16, wherein forming the first film comprises forming a layer of manganese dioxide nanowires over a layer of single-walled carbon nanotubes.

19. The method of claim 16, wherein the second film comprises an indium oxide nanowire/single-walled carbon nanotube hybrid film.

20. The method of claim 16, wherein forming the second film comprises forming a layer of indium oxide nanowires over a layer of single-walled carbon nanotubes.

21. The method of claim 16, further comprising arranging a separator between the first film and the second film, wherein the electrolyte is in contact with the separator.

22. An electrochemical capacitor formed by the method of claim 16.
